(19) United States
(12) Patent Application Publication
(10) Pub. No.: US 2008/0306752 A1
(43) Pub. Date: Dec. 11, 2008

(54) Method and system for automatic testing in a business scenario environment

(76) Inventors: Andre Wagner, Sinsheim (DE); Andreas Poth, Weingorten (DE); Bare Said, St Leon (DE); Christoph Lubbe, Bruchsol (DE); Horst F. Schaude, Kraichtal (DE); Silke Storch, Rauenberg (DE); Tobias Brandl, Walldorf (DE)

Correspondence Address: KENYON & KENYON LLP, ONE BROADWAY, NEW YORK, NY, 10004, US

(21) Appl. No.: 11/811,229

(22) Filed: Jun. 8, 2007

(51) Int. Cl. G06Q 10/00

(52) U.S. Cl. 705/1

(57) ABSTRACT

A software tool for automatically executing relevant testing in an Application Platform. When an object in an Application Platform is changed, testing may be executed for the changed object as well as any related objects.

### FIELD OF INVENTION

The present invention relates to a tool for automatically executing relevant testing in an Application Platform. Specifically, when an object in an Application Platform is changed, testing may be executed for the changed object as well as any related objects.

### BACKGROUND INFORMATION

During software development and especially at the software development-to-production phase, different efforts are made to ensure that the software produced is of a high quality. This begins on the coding level with unit tests. In a unit test, a specific compiling unit is tested without regard to its relationship with other compiling units.

In an Application Platform, a number of objects are defined, such as Process Components, Business Objects, Inbound/Outbound Process Agents, Interfaces, Operations, and Messages. Integration Scenarios define exactly which objects interact with other objects and how they interact. Test plans are designed based on the Integration Scenarios, i.e., the relationship between the objects. After the successful execution of these test plans, it is guaranteed that the Application Platform will be free of known errors.

Code testing is a known useful technique to ensure that Application Platforms are error-free. However, after a correction is made to an object in an Application Platform, currently there is no quality assurance beyond the direct impact area of the correction. Only the code sections that are directly impacted by the correction are currently tested. Therefore, there may be code sections outside the direct impact area of the correction that are not tested. The result is that there may be undetected errors resulting from the change. It would be beneficial to test all objects that are related to the changed object, whether directly or indirectly affected, to maintain the integrity of the system and to ensure that the Application Platform remains error-free.

### BRIEF DESCRIPTION OF THE DRAWINGS

FIG. 1 is a simplified block diagram of a computer system according to an embodiment of the present invention.

FIG. 2 is a diagram of an embodiment of a decision tree saved in memory.

FIG. 3 is a dataflow diagram illustrating the operation of an embodiment of the present invention.

FIG. 4 is dataflow diagram illustrating the operation of an embodiment of the present invention.

### DETAILED DESCRIPTION

Embodiments of the present invention work cooperatively with existing Application Platform objects to automatically test all objects that are related to a changed object. An object may be associated with related objects within an Application Platform. Each object may also be associated with a test plan to test its integrity. When an object in the Application Platform is changed, the identity of the changed object may be sent by the system as an input to a component relation module, which uses the input to navigate a backend resource which maintains the relationships between objects and test plans. The resource may be, for example, a database accessible via an intranet. The component relation module may traverse the database and obtain the identity of test plans associated with the changed object. The component relation module may return this information to the CPU which may execute the identified test plan.

Additionally, the objects associated with the changed object may be identified, and the test plans associated with those related objects may also be executed automatically. There may be another resource in the backend which maintains the relationships between objects. For example, the resource may be a database based on a decision tree accessible via an intranet. The component relation module may traverse the decision tree and obtain the values for objects related to the changed object. Then, the field completion module may obtain the test plans associated with the related objects as discussed above. The component relation module may return this information to the CPU which may execute the identified test plans.

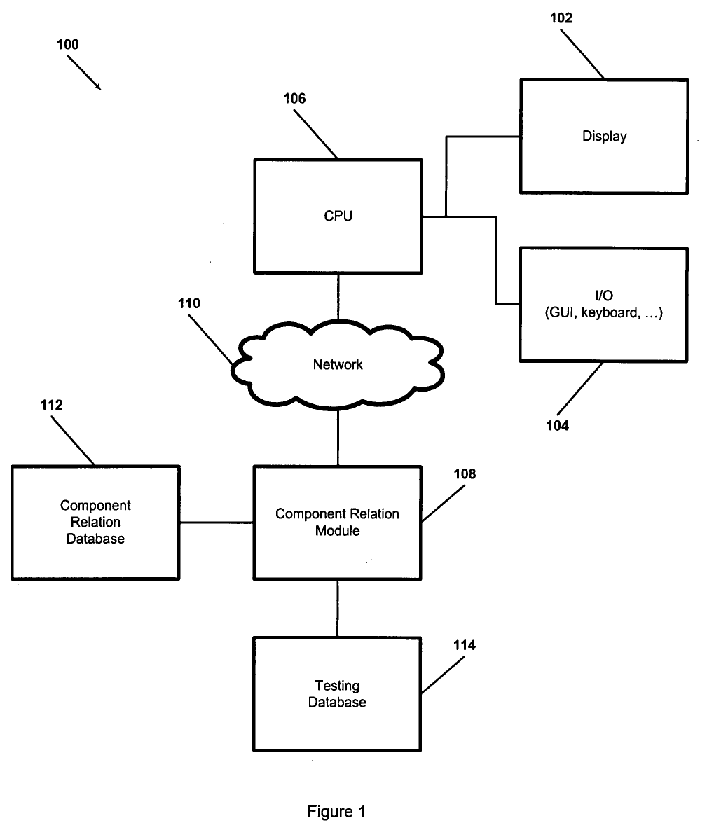

FIG. 1 is a simplified block diagram of an exemplary computer system 100 suitable for use with the present invention. As illustrated, network 110 may include network entities (not shown) that perform test plans on an individual terminal 106; such entities are known in the art. According to an embodiment of the invention, the network 110 may include a component relation database 112 that stores relationships between objects in the Application Platform. Further, network 110 also may include a testing database 114 which stores the test plans associated with each object in the Application Platform. Network 110 may also include a field completion module 108 that searches and accesses information from the component relation database 112 and the testing database 114.

A user may change an object in the Application Platform by way of an input/output device 104, such as a keyboard or a mouse, for example. Any parameter value of the object may be changed. For example, a business object may contain services provided by a business object and data of the object itself. Either the services that may be performed or the data stored within the object may be changed. The CPU 106 may detect this change and receive the identity of the changed object as input. The identity of the changed object may be passed onto the component relation module 108 via network 110. The component relation module 108 may then search the testing database 112 to determine the test plan that is uniquely associated with the changed object. When the component relation module 108 finishes searching the testing database 112, it may access the test plan associated with the changed object. Thereafter, the component relation module 108 may return the accessed test plan to the CPU 106 via network 110. The CPU 106 may perform the test as instructed by the retrieved test plan.

If the test is not performed successfully, the CPU 106 may return an error message to the user via display 102 indicating that the changed object did not pass the test and must be changed.

If the test is performed successfully, the CPU 106 may pass the input (i.e. the identity of the changed object) to the component relation module 108 via network 110. The component relation module 108 may then search the component relation database 114 to determine the objects that are associated with the changed object. The component relation database 114 may contain a decision tree representing the hierarchy of objects in the Application Platform. The objects that are related to the changed object may be determined by traversing the decision tree. When the component relation module 108 finishes searching the component relation database 114, it may access the objects related to the changed object. Thereafter, for each object related to the changed object, the component relation module 108 may search the testing database 112 to determine the test plans associated with that object. Once the test plans for all objects related to the changed object have been accessed, the component relation module 108 may return the accessed test plans to the CPU 106 via the network 110. The CPU 106 may then perform the test plans.

If the additional tests are performed successfully, the CPU 106 may returns a message to the user via display 102 indicating that the changed object passed all tests. Alternatively, if the additional tests are performed successfully, no message may be returned to the user.

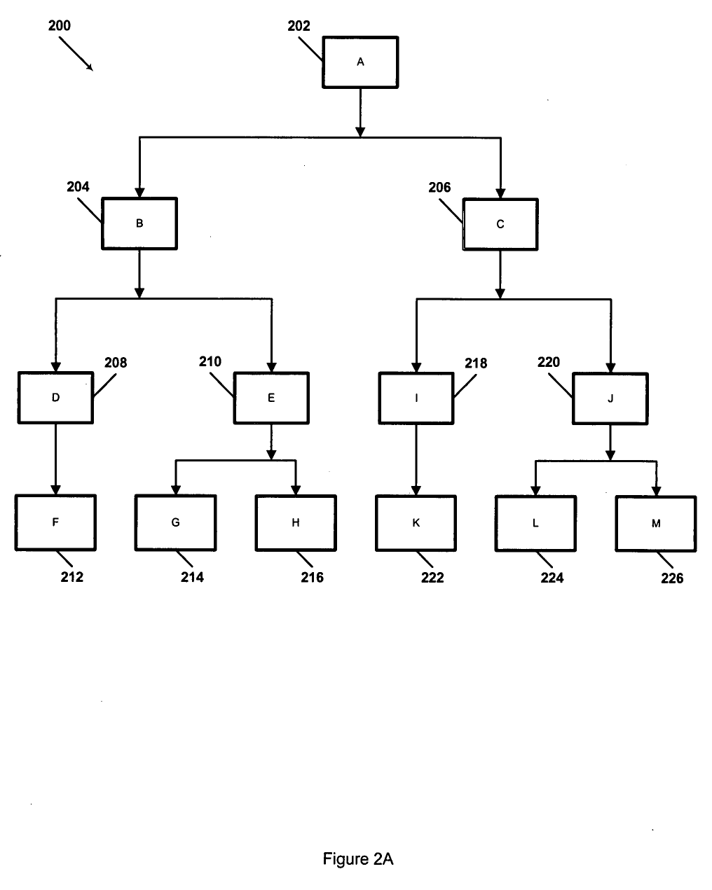

FIG. 2 illustrates an exemplary embodiment of decision tree 200 which is contained in the component relation database 114 which relates an object to other objects. Although FIG. 2 presents an example based on a decision tree data structure, the present invention is compatible with any searchable data structure capable of relating a user-entered information item to other information.

There may be different degrees of relation for an object to be considered “related” to the changed object. For example, an object may be considered related to the changed object if it is below the changed object in the hierarchy, i.e. if it is a descendant of the changed object. As another example, an object may be considered related to the changed object if it is within one generation of the changed object, i.e. if it is a child or parent of the changed object.

As another example, an object may be considered related to the changed object if it is a parent of the changed object or if it is a descendant of the changed object. For example, if the changed object was B 204, then the component relation module 108 would first traverse the decision tree 200 to determine which objects were below B 204 in the hierarchy. The objects below B 204 in the hierarchy are: D 208, E 210, F 212, G 214, and H 216. The component relation module 108 would then traverse the decision tree 200 to determine which objects were above B 204 in the hierarchy. The object above B 204 in the hierarchy is A 202. The component relation module 108 would then search the testing database 112 to determine which test plans were associated with objects D 208, E 210, F 212, G 214, and H 216, and A 202.

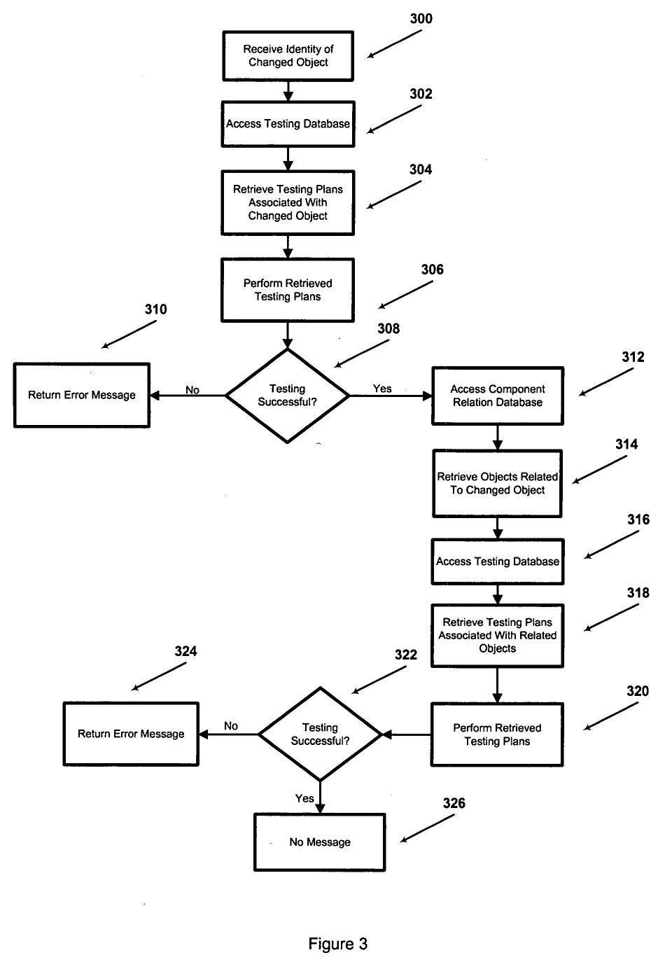

FIG. 3 is a dataflow diagram illustrating an operation of the component relation module 108 for one embodiment of the present invention. The method begins when a user changes an object in the Application Platform by way of an input/output device 104, step 300. Any parameter value of the object may be changed. For example, a business object may contain the identities of services provided by a business object and data of the business object itself. A user may change, for example, either the services that may be performed or the data stored within the object itself. The CPU 106 may receive the input (i.e. the identity of the changed object) and pass it onto the component relation module 108 via the network 110. The component relation module 108 may then search the testing database 112 to determine the test plan that is uniquely associated with the changed object, step 302. When the component relation module 108 finishes searching the testing database 112, it may access the test plan associated with the changed object, step 304. Thereafter, the component relation module 108 may return the accessed test plan to the CPU 106 via the network 110. The CPU 106 may perform the test as instructed by the retrieved test plan, step 306.

The CPU 106 may then determine whether the test has been performed successfully, step 308. If the test has not been performed successfully, the CPU 106 may return an error message to the user via display 102 indicating that the changed object did not pass the test and must be changed, step 310.

If the test has been performed successfully, the CPU 106 may pass the input (i.e. the identity of the changed object) to the component relation module 108 via network 110. The component relation module 108 may then search the component relation database 114 to determine the objects that are associated with the changed object, step 312. The component relation database 114 may contain a decision tree representing the hierarchy of objects in the Application Platform. The objects that are related to the changed object may be determined by traversing the decision tree. The definition of objects related to the changed object may be pre-determined by the CPU 106 or by the user, as discussed above. When the component relation module 108 finishes searching the component relation database 114, it may access the objects related to the changed object, step 314. Thereafter, for each object related to the changed object, the component relation module 108 may search the testing database 112 to determine the test plans associated with that object, step 316. Once the test plans for all objects related to the changed object have been accessed, the component relation module 108 may return the accessed test plans to the CPU 106 via network 110, step 318. The CPU 106 may perform the tests as instructed by the retrieved test plans, step 320.

The CPU 106 may then determine whether the additional tests have been performed successfully, step 322. If the additional tests have not been performed successfully, the CPU 106 may return an error message to the user via display 102, step 310. This error message may contain a general message indicating that the changed object or an object related to the changed object failed a test and must be changed. Alternatively, a specific error message may be returned to the user indicating exactly which related object did not pass its test. If the additional tests are performed successfully, the CPU 106 may not display any message to the user, step 326.

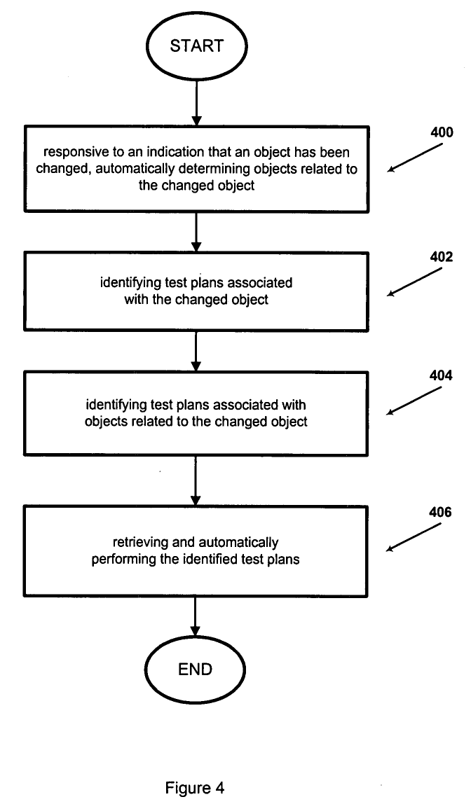

FIG. 4 is a dataflow diagram illustrating operation of the component relation module 108 for another embodiment of the present invention. The method begins when the component relation module 108 automatically determines the objects that are related to a changed object in response to an indication that an object has been changed, step 400. This may be accomplished by searching the component relation database 112. The component relation module 108 may then identify test plans that are associated with the changed object, step 402. This may be accomplished by searching the testing database 114. The component relation module 108 may then identify test plans associated with objects related to the changed object, step 404. This may also be accomplished by searching the testing database 114. Thereafter, the component relation module may retrieve and automatically perform the identified test plans, step 406. The identified test plans may be retrieved from the testing database 114.

Several embodiments of the invention are specifically illustrated and/or described herein. These embodiments may be used in combination with each other to provide alternative embodiments. It will be appreciated that modifications and variations of the invention are covered by the above teachings and within the purview of the appended claims without departing from the spirit and intended scope of the invention.

What is claimed is:

1. A method of automatically testing a changed object and a related object, comprising:
responsive to an indication that an object has been changed, automatically determining objects related to the changed object;
identifying a test plan associated with the changed object;
identifying a test plan associated with any determined objects related to the changed object;
retrieving the identified test plan associated with the changed object and the identified test plan associated with the related object; and
automatically performing the identified test plans.

2. The method of claim 1, wherein the receiving indication includes the CPU automatically detecting that an object has been changed.

3. The method of claim 1, wherein the automatically determining includes searching through a data structure relating the changed object to other objects.

4. The method of claim 1, wherein the changed object is changed by a user.

5. The method of claim 1, further comprising returning an error message if any of the test plans do not execute properly.

6. An article of manufacture comprising a computer readable medium storing instructions adapted to be executed by a processor, the instructions, when executed, defining a method for automatically testing a changed object and its related objects, the method comprising:
responsive to an indication that an object has been changed, automatically determining objects related to the changed object;
identifying and retrieving test plans associated with the changed object;
identifying test plans associated with objects related to the changed object; and
retrieving and automatically performing the identified test plans.

7. The method of claim 6, wherein the receiving indication includes the CPU automatically detecting that an object has been changed.

8. The method of claim 6, wherein the automatically determining includes searching through a data structure relating the changed object to other objects.

9. The method of claim 6, wherein the changed object is changed by a user.

10. The method of claim 6, further comprising returning an error message if any of the test plans do not execute properly.

11. A computer system for automatically testing a changed object and its related objects, comprising:
responsive to an indication that an object has been changed, an arrangement for automatically determining objects related to the changed object;
an arrangement for identifying and retrieving test plans associated with the changed object;
an arrangement for identifying test plans associated with objects related to the changed object; and
an arrangement for retrieving and automatically performing the identified test plans.
